(19) United States
(12) Patent Application Publication
(10) Pub. No.: US 2013/0006696 A1
(43) Pub. Date: Jan. 3, 2013

(54) SYSTEM AND METHOD FOR AN EXTENSIBLE WORKFLOW MANAGEMENT

(75) Inventors: Kenny Wai-doon LOUIE, Richmond (CA); Chung Foo WU, Richmond (CA); Patrick-Alain Joseph NUMAINVILLE, Richmond (CA); Vernon-Joseph CHIN, Richmond (CA); Pui Wing Arthur LO, Richmond (CA); Shuk Yee Wendy LEE, Richmond (CA); Thomas LIGOCKI, Richmond (CA)

(73) Assignee: CLEVEST SOLUTIONS INC., Richmond (CA)

(21) Appl. No.: 13/615,181

(22) Filed: Sep. 13, 2012

Related U.S. Application Data
(63) Continuation of application No. 12/239,374, filed on Sep. 26, 2008, now abandoned.
Application No. 12/239,374 is a continuation-in-part of application No. 12/196,069, filed on Aug. 21, 2008.

(51) Int. Cl. G06Q 10/06

(52) U.S. Cl. 705/7.26

(57) ABSTRACT

A workflow management system provides a GUI Configurability tool that allows an end user to configure the system's workflow screens, workflow logic and data fields without the need to rewrite any programs. The system allows each workflow screen to represent and assist each individual task within a business process that may be defined and illustrated by a flowchart. The workflow screens work in conjunction with workflow logic to create an accurate one-to-one mapping of the individual tasks and decision logic within a business process flowchart. The system provides published interfaces that allow the use of third party hardware and software within workflows. The system also provides published interfaces to integrate extensible code that perform custom functions within the system.

### RELATED APPLICATION

This application is a continuation of U.S. patent application Ser. No. 12/239,374 filed Sep. 26, 2008, which is a continuation in part of U.S. patent application Ser. No. 12/196,069 filed Aug. 21, 2008. The specifications of said applications are hereby incorporated by reference in their entireties.

### FIELD OF INVENTION

The present invention relates to workflow management systems, and more particularly, systems for providing a configurable workflow management application capable of integrating third party proprietary mobile hardware and software into the system.

### BACKGROUND OF THE INVENTION

Workflow management software applications are used by many businesses to increase productivity and efficiency by assisting workers and/or automating the control of business functions and processes, such as work orders, logistics, inventory management, manufacturing, transaction approval, validation, etc.

Each business entity implements its own unique business processes that are a function of its industry, organizational structure and unique business plan. Therefore a workflow management application needs to have the capability to represent and accommodate the unique processes and requirements of a variety of businesses.

Prior workflow applications are typically created as customized programs to meet the specific needs of an individual business at a particular time. As business plans and processes change, skilled programmers are required to rewrite and recompile the system to modify the system's screens, data fields, workflow logic, and interfaces. Changes to the system are therefore slow to implement and costly in terms of time and resources.

The challenge is to design a workflow management application that is configurable by the user, and is capable of being modified without suffering from any downtime.

Workflow management applications are often employed in industries, such as energy utilities and water utilities, in which mobile workers use mobile hardware and software to interact with onsite devices. As a result, different companies may require the use of specific mobile hardware and proprietary application program interfaces (API) that are unique to their business processes. To assist mobile workers in the execution of their business functions, workflow management applications need to have the capability of integrating third party hardware and proprietary software with the workflow management system.

Further extensibility of a workflow management system may also be required to accommodate unanticipated needs or complex needs of different businesses. The challenge is to provide a means of integrating additional customer specific features into the workflow management system as extensible code and without the need to rewrite the application.

What is needed, and is herein presented, is a configurable workflow management system that is capable of integrating proprietary mobile hardware and software that also provides a means of integrating customer specific extensible code.

### SUMMARY OF THE INVENTION

The present invention is a workflow management system for providing a configurable workflow management application capable of integrating third party proprietary mobile hardware and software into the system. The system is also capable of integrating customer specific features as extensible code and without the need to rewrite the program. The workflow management system assists in managing resources that include a workforce, and in managing efficient and accurate performance of business processes. Such business processes are also called work projects or work orders, which may involve multiple tasks and sub-projects.

Each business entity may have many business processes with unique tasks and requirements that need to be accommodated by a workflow management system. The different business process of each business can be clearly understood and mapped by a flowchart. A flow chart may be used to identify the individual tasks and decision logic of each business process.

The workflow management application presented herein provides workflow screens to represent and assist each task that is identified within the business flowchart. Workflow screens are detail screens that are part of the workflow logic. The workflow screens are presented to workers on computing devices which may include laptop computers, Personal Data Assistants (PDAs), Smart Phones, and other mobile devices. Workflow screens assist workers in the accurate completion of individual tasks within a business process. A workflow screen may provide information to assist in the performance of a specific task, or receive data from a worker to process relevant decision logic.

Workflow screens work in conjunction with workflow logic that is defined and illustrated by the business flowchart. The ability to configure workflow screens according to a business process flowchart enables the system presented herein to accommodate specific procedures and requirements of different business processes and business entities. The workflow screens also provide one-to-one mapping of screens with each individual task and business logic of a flowchart. The one-to-one mapping of the workflow screens with the flowchart allows simple verification of the workflow design with the business process.

The system provides a graphical user interface (GUI) configuration tool to create and configure the workflow screens, workflow logic, data fields, and dispatcher screens that are required. The dispatcher screens are used by the system's dispatcher tool to assist the management and scheduling of work orders with resources, individual workers, or groups of workers.

The information for each work order is organized as a data entity referred to as an “Order Type”. An Order Type defines the workflow screens, workflow logic, data fields, and value lists for each work order. The dispatcher tool and mobile applications may process the information within an Order Type in a structured fashion.

The method of using Order Types to organize information for each business process enables information to be supplied to the dispatcher tool and the workers' mobile devices on an as-needed basis. Organizing the information by Order Types, and the partitioning of the screens and workflow logic, reduces the complexity of the logic and allows the information to be processed on mobile devices that have limited memory and processing capabilities.

The end user of the system may use the GUI Configuration tool to create and manipulate Order Type information, including workflow screens, workflow logic and data fields, and utilize them as part of the workflow management system without having to create custom code or recompile any parts of the system.

The system provides a method of extensibility that allows the use of third party hardware and software to be employed during the processing of a work order. The system integrates third party hardware and software functions through custom workflow screens. In the framework of custom workflow screens end-users can create and implement custom user interfaces with specific controls. The custom workflow screens take the place of workflow screen definitions provided by the systems GUI Configuration tool. End users can implement the custom controls on a client device, and invoke the functions of third party hardware and software that are outside of the workflow management system. A software interface is provided to link the workflow management system with external hardware and software and allow data to be queried from and returned to the system.

The workflow management system is also capable of accommodating the unanticipated needs and complex needs of various businesses by providing the means to integrate extensible code. The system integrates extensible code to allow customer specific functions to be executed within the system without having to rewrite the application. Customer specific functions may include specific logic functions, automated system tasks, and/or automated system alerts.

The system provides published interfaces to integrate extensible code. The use of published interfaces allow both the extensible code and the main codestream to be independently upgraded or modified and remain mutually compatible. Therefore, customer specific extensible code does not need to be rewritten when upgrades or modifications are made to the system.

A system for dynamically integrating an application screen, a workflow logic for a business workflow and an extensible code is provided, the system having an application program for executing the application screens, the workflow logic and the extensible code; a database containing a plurality of fields and repeatables, each of the fields and repeatables corresponding to a business workflow; and the database containing an extensible code; a graphical user interface tool producing application screens presenting the fields in conjunction with the workflow logic of the business workflow; wherein the workflow logic for the business workflow is creatable using defined functions, logic operators, key-words, and the fields. A new or modified definition of a screen representing the business workflow, a dispatcher, or a mobile device; or of one of the fields or repeatables, or of the workflow logic or the extensible code, may be made available as they are added to the database.

A method of executing a business plan is provided, including the steps of: providing a graphic user interface, the graphic user interface providing a plurality of editable screens for implementing steps within a workflow associated with the business process; wherein at least one of said screens is associated with extensible code, the extensible code related to input from a third party device. Each of the plurality of screens may be associated with separate workflow logic. The workflow may include definitions of workflow screens, dispatcher screens, mobile device screens, data fields, and the workflow logic, and each of the definitions may be stored as a data object in a database and made available to an application software as an executable construct.

The graphic user interface may integrate a custom screen interface into a workflow, to allow the use of an associated custom screen definition, custom control, and proprietary application program interface, and enable the integration of a third party device and associated software. The extensible code may be integrated with the interface to allow functions to be executed at one or more processing points of a work. Alternatively, the extensible code may be integrated with the interface to allow the use of customer specific system tasks.

The interface may schedule and configure an implementation of the extensible code to perform specific system tasks. The extensible code may be integrated with the interface to allow the use of system alerts. The interface may implement extensible code that performs the system alerts.

### BRIEF DESCRIPTION OF THE DRAWINGS

FIG. 1 illustrates a block diagram of an exemplary computing environment in which the present invention may be implemented according to one preferred embodiment.

FIG. 2 illustrates an exemplary business process.

FIG. 3 illustrates an exemplary workflow based on the business process that is defined by FIG. 2.

FIG. 4 illustrates the system's GUI configuration tool that allows a user to configure the workflow screens, data fields, and workflow logic.

FIG. 5 illustrates an exemplary business workflow that employs the use of a custom screen interface.

FIG. 6 illustrates a custom screen interface that is used to control a third party GPS device.

FIG. 7 shows an example of extensible code for a custom screen interface that controls a third party GPS device.

FIG. 8 and FIG. 9 show examples and definitions of published interfaces that may be used by the system to integrate custom screen interfaces and extensible code.

FIG. 10 shows an example of extensible code for Order Event Logic that is executed on a server.

FIG. 11 illustrates the use of an exemplary GUI tool to select a particular system task for implementation.

FIG. 12 illustrates the use of an exemplary GUI tool to schedule the implementation of system task according to various time intervals.

FIG. 13 illustrates the use of an exemplary GUI tool to display the particular system tasks that have been scheduled to be run.

FIG. 14 illustrates an exemplary process to implement system tasks within a workflow management system.

### DETAILED DESCRIPTION OF AN ILLUSTRATIVE EMBODIMENT

The invention and its principles presented herein may be produced with many different configurations, forms and design elements. The drawings, illustrations and description of the invention herein are described with the understanding that the present disclosure is to be considered as an exemplification of the principles of the invention and is not intended to limit the invention to the embodiment illustrated. Those skilled in the art will envision many possible variations within the scope of the present invention. To better appreciate the present invention it will be illustrated in an example embodiment within the context of managing mobile workers in the electric utilities industry.

In this document the terms “third party device” or “third party hardware” means a device provided by a party unaffiliated with the party operating the system or carrying out the business workflow.

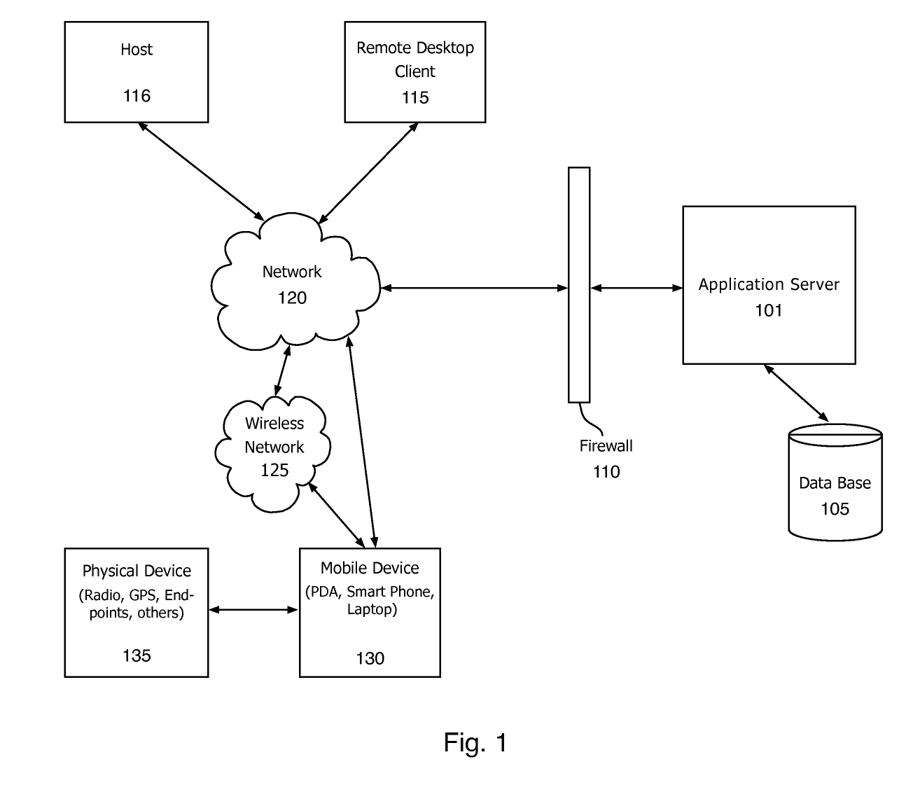

FIG. 1 shows an exemplary computing environment in which the present invention may be implemented. Those skilled in the art will appreciate that the workflow management system may be implemented with other computer system configurations.

Remote desktop clients 115 and/or host 116 and wireless mobile clients 130 may access server 101 and database 105 through a wireless network 125, and/or network 120, such as the Internet. Host 116 provides and receives information regarding work orders to and from the application on server 101. Mobile devices 130 include portable computing devices that send and receive messages over wireless network 125, and/or devices that work in a disconnected mode and send and receive information when a network connection is established. Mobile devices are client devices, including cellular phones, smart phones, PDAs, handheld computers, laptop computers, tablet computers, and the like. Mobile devices 130 may include at least one other client application that is configured to receive content from third party computing devices and/or physical devices 135 that are outside of the workflow management system. Database 105 is used to store information related to data fields, workflow logic and application screens.

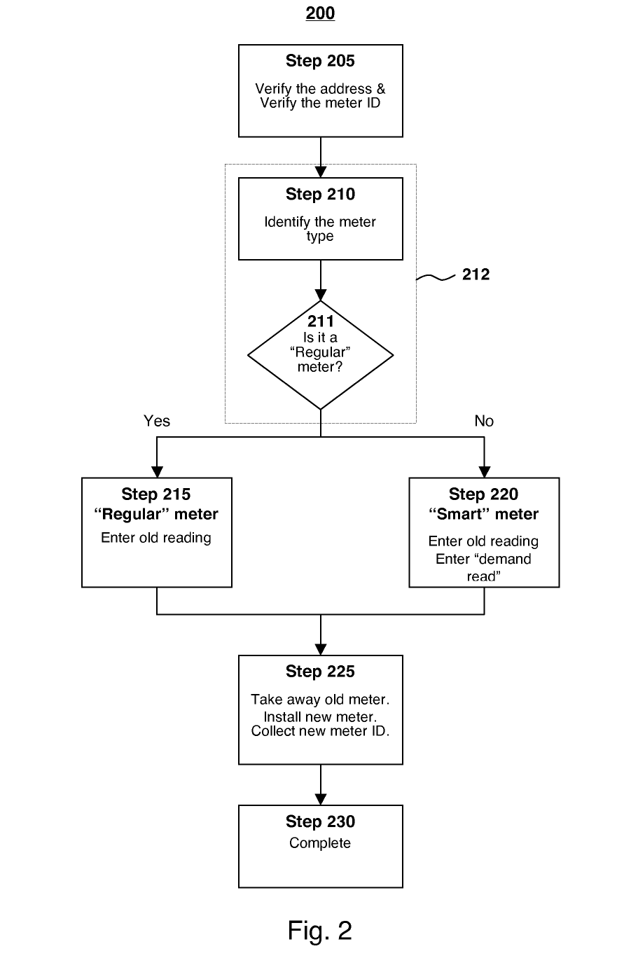

Referring to FIG. 2, business processes, which may also be called workflows, work projects or work orders, can be defined and organized by a flowchart, such as flowchart 200. The flowchart represents the business process by defining and mapping all the individual tasks that may be required in the course of executing a business process. An example of constructing a flowchart for a business process can be easily understood where a business uses a separate paper form for each individual task. The paper forms can be organized to form a business flowchart as illustrated in FIG. 2.

FIG. 2 illustrates an exemplary business process for a meter replacement workflow. Workers perform the meter replacement work according to the necessary processes that are defined by flowchart 200. In Step 205 of flowchart 200, workers verify that they have arrived at the correct address and verify the correct meter ID as stated in their work order. In Step 210 the worker identifies if the meter is a “Regular” meter, or a “Smart” meter. If the meter is a “Regular” meter, the decision logic at Step 211 has the worker perform Step 215, which requires the entry of an “Old reading”. If the meter is a “Smart” meter the decision logic at Step 211 has the worker perform Step 220, which requires the entry of an “Old reading” and the entry of a “Demand read”. The worker then performs Step 225, which requires the removal of the old meter, the installation of a new replacement meter, and the collection of a new meter ID. Step 230 indicates the completion of the business process.

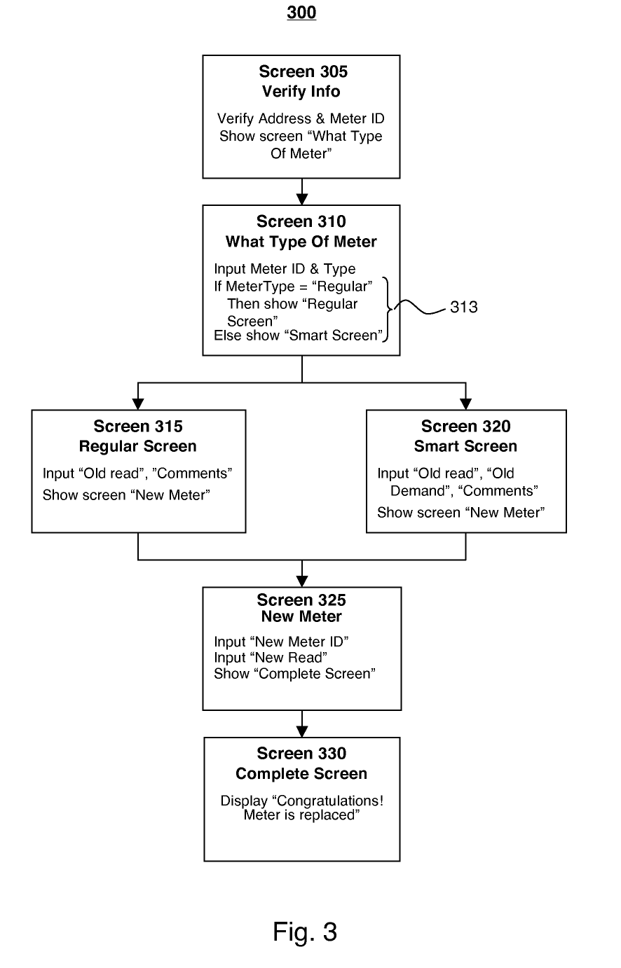

The workflow management system presented herein uses graphical user interface (GUI) screens to represent and assist with completion of each step within a business process. FIG. 3 shows the layout of multiple GUI screens that represent the business process shown in FIG. 2.

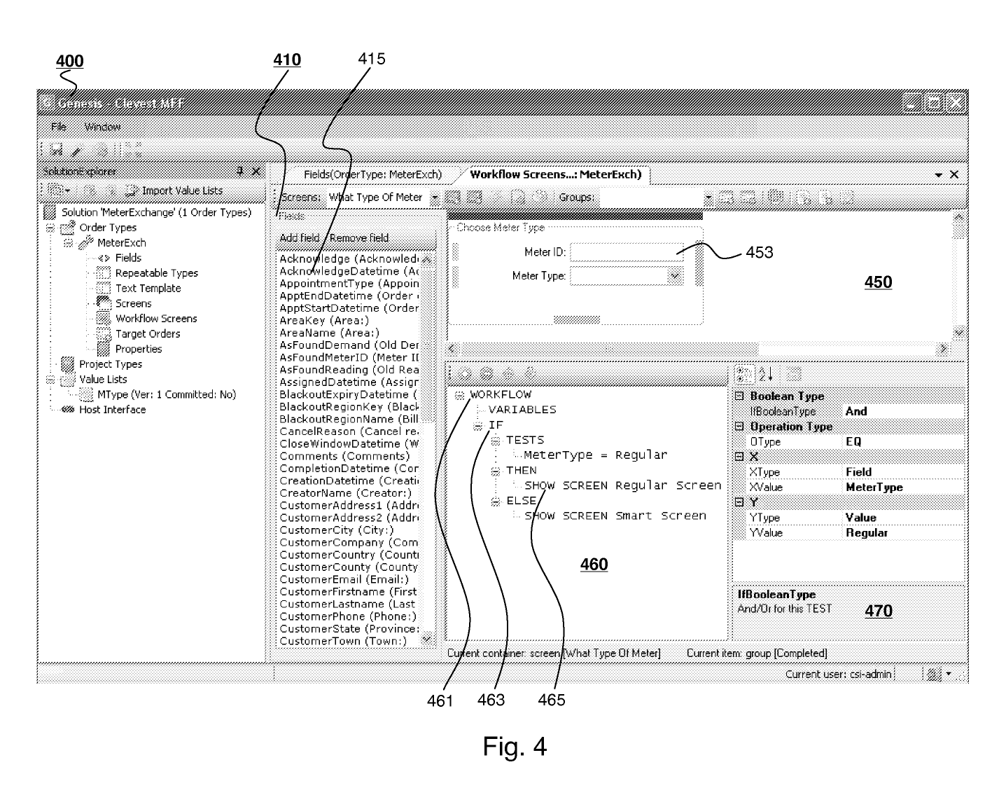

FIG. 4 shows the system's GUI configuration tool 400 that is used to translate business flowchart 200 to a GUI screen type representation as illustrated in FIG. 3. Each screen may be presented on mobile devices to assist workers in a business process.

The system's GUI configuration tool 400 allows end users to create and/or edit the client application's workflow screens 450 and to simultaneously view, create and/or edit the workflow logic 461 that works in conjunction with the workflow screens 450.

FIG. 4 illustrates the components in the GUI Configuration tool 400. The GUI Configuration tool 400 provides:
a screen area with Workflow Editor 460 for the user to create and/or edit the workflow logic 461;
a screen area with Screen Editor 450 for the user to view, create and/or edit the corresponding workflow screen that works in conjunction with the workflow logic 461;
a screen area with Context Sensitive Editor 470 that provides a context sensitive menu of allowable parameters to create and/or edit logic statements within the workflow logic 461; and
a screen area with Fields Menu 410 that provides data fields 415 and repeatable data fields. Repeatable data fields, also referred to herein as “repeatables” are fields that are a combination of fields that tend to repeat many rows and are also known as tables in an HTML paradigm.

Once defined, the workflow screens and the workflow logic may be stored in database 105 for use by one or more clients 115, 130 when executing workflows.

The screens work in conjunction with workflow logic 461 that is defined by the business process 200. Each screen may be configured with data fields 453 to retrieve information and/or provide workers with information that is relevant to a particular task. The screens may also be configured to display information from the processing of workflow logic 461, and/or request data from workers to perform additional workflow logic.

The workflow logic 461 may perform decision logic including tests, validation rules, “If-Then-Else” functions 463 and “While” loops to assist the workers in the accurate and efficient completion of business processes.

The workflow logic 461 links each of the screens that are created for the various tasks of a workflow, and displays the appropriate screens in the proper sequence according to the business logic. The workflow logic 461 may be configured to link and display screens by employing a “Show screen” command 465.

Workers are presented with the next appropriate screen within the business process after they complete the required work for the current screen and execute the workflow logic.

FIG. 3 illustrates the arrangement of workflow screens in a workflow 300 to represent the individual tasks that are defined and mapped by the business flowchart 200 in FIG. 2.

The “Verify Info” screen 305 represents “Step 205” of the business process 200. The screen requires workers to visually verify that they are at the correct address with the correct meter ID according to the work order. After the address and meter ID have been verified as correct, the worker presses the “Next” button to proceed to the next screen.

The “What Type Of Meter” screen 310 represents “Step 210” of the business workflow 200. The screen requires the worker to enter the meter ID and the meter type. The screen also incorporates workflow logic 313 that corresponds to the decision logic 211 of the business workflow 200. The use of the GUI configuration tool 400 to configure the “What Type Of Meter” screen 310 is illustrated by FIG. 4. The screen is configured with the necessary data fields 453 to allow workers to input the Meter ID and the Meter Type. The workflow logic 461 is configured in accordance to the decision logic 211 of the business workflow 200, and is configured to show the “Regular Screen” 315 if the worker identifies that the meter is a “Regular” meter. Where the meter is identified to be other than a “Regular” meter, the workflow logic 461 is configured to show the “Smart Meter Info” screen 320. The “What Type Of Meter” screen 310 is effectively comprised of both “Step 210” of the business workflow 200 and the subsequent decision logic 211 as represented by the dashed line 212 in FIG. 2. The “What Type Of Meter” screen 310 illustrates how workflow screens work in conjunction with workflow logic, and may be configured to display and/or retrieve necessary information, and also process relevant decision logic to support the accurate execution of a business process.

The “Regular Screen” 315 represents “Step 215” of the business workflow 200. The screen requires the worker to enter a meter reading for the old meter into the “Old Read” field and provides a “Comments” field to allow the entry of applicable comments.

The “Smart Meter Info” screen 320 represents “Step 220” of the business workflow 200. The screen requires the worker to enter data for the “Old Read” field and the “Old Demand” field, and also provides a “Comments” field to allow the entry of applicable comments.

After entering the necessary information from the old meter, the workflow 300 progresses to the “New Meter” screen 325, which represents “Step 225” of the business workflow 200. The worker then physically replaces the old meter with a new meter and enters the information that is requested from the “New Meter” screen 325. The worker enters the new meter ID and a new meter reading in the “New Read” field. The workflow logic will progress to the “Completed” screen 330 after the information has been entered.

The “Completed” screen 330 represents “Step 230” of the business workflow 200. The screen is configured to display a message to inform the worker that the meter replacement work has been successfully completed.

The system's GUI configuration tool 400 enables the user to configure screens that display the necessary and sufficient amount of information to assist the worker in executing the immediate task at hand. By configuring each screen with information to assist one particular task within a business process 200, the user is able to create screens that are free of unnecessary information that may confuse the worker.

The method of representing the individual tasks of a business process with separate screens allows the partitioning of the screens and the workflow logic. The partitioning of the screens reduces the complexity of the logic, and greatly reduces the memory and processing requirements, thereby allowing a workflow to be implemented on mobile devices which have significant limitations in memory and processing capability, such as PDAs and Java 2 Platform Micro Edition (J2ME) Mobile Phone applications.

The GUI configuration tool 400 organizes the information for each workflow as an Order Type. An Order Type is an object that defines a workflow with the definitions for the dispatcher screens, workflow screens, data fields, and the workflow logic.

GUI configuration tool 400 integrates the Order Type screen definitions and workflow logic as executable constructs that are made available to the application software. New and/or edited Order Type definitions are interpreted by the application, without requiring the re-writing or re-compiling of the application software and without interrupting the operability of the application at any time.

The system integrates workflow logic using programming language based on Extensible Markup Language (XML), which provides programming constructs such as variables, conditions, operations, loops and custom actions and allows users to employ variables and global variables to assist in the logic. The language is loaded as an XML document when the user uploads changes to the database.

The system may use the Document Object Model (DOM) methods to traverse the workflow logic. The system uses the DOM to execute the XML instructions as defined by the logic.

A common project is written once and compiled for either desktop, server or PDA consumption. The common project then reads the XML definition for the document and allows the clients to utilize the document and workflow. A client application program de-serializes the XML code into objects that know how to logically evaluate the XML command nodes. The application loads the relevant document files at start up and reloads updated files when notified.

In an example embodiment the system uses a build process that takes the GUI tool 400 output, and compiles and links the modules. The GUI output feeds an upload process into the database schema. The process builds and uploads multiple order types.

The Internal Build tool and database schema deals with both pre-defined or business rule fields, as well as user-defined fields, specific to each user-defined order type.

A Structured Query Language (SQL) Server, or Oracle database's Extensible Markup Language (XML) component is used to define and encapsulate the customer-defined fields as a single large XML data string within one field of database 105. This method hides the complexity and variability of these fields.

This innovative approach allows the user-defined order type to effectively be decoupled from the process, greatly simplifying the build process and database upload process.

An XML query language, such as XQuery, that can use the structure of XML to express queries across all kinds of data stored or expressed as XML, is used to extract and process the user-defined fields in an efficient manner from database 105.

The build process employs the innovative use of XML data to decouple the order type and hide the complexity of the user-defined fields from the build process. This provides a reliable and efficient build process that prevents overly complex builds.

The workflow management system is extensible with custom screens that allow end users to implement custom user interfaces and controls. Custom screens allow the use of third party application program interfaces (API) to invoke and/or control third party hardware 135 that are outside of the workflow management system.

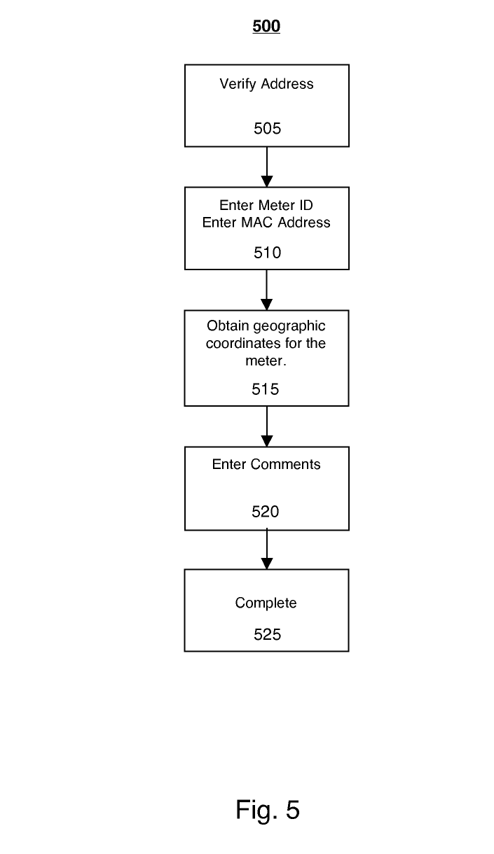

FIG. 5 illustrates an exemplary business workflow 500 that employs a custom screen. The business workflow 500 requires a worker to obtain the geographic coordinates for a newly installed meter by using an external Global Positioning System (GPS) device. The GPS device represents a third party device 135 that is external to the workflow management system. The workflow management system is able to assist the worker's task by incorporating a custom screen that interfaces with the GPS device via Bluetooth.

In the first task of the business workflow, at step 505, the worker verifies that he/she has arrived at the correct address.

The worker then enters the meter ID and the MAC address for the new meter at step 510.

After the worker has entered the meter ID and MAC address for the new meter, the workflow logic then displays the custom GPS screen at step 515. The GPS screen definitions and controls are then replaced with custom screen definitions and controls that are provided in a Dynamic Link Library (DLL) that is written by an in-house programmer or by a third party developer.

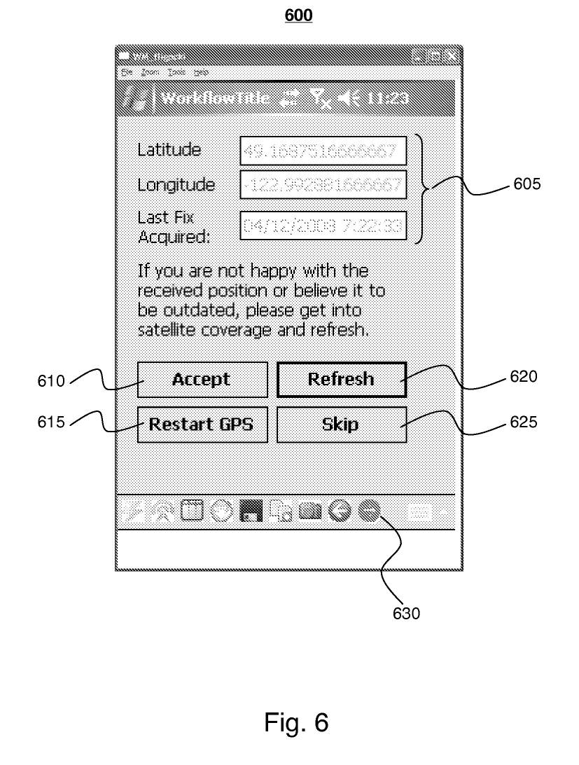

FIG. 6 shows an exemplary custom screen interface 600 for the GPS screen 515 within the workflow 500. Custom screen interface 600 provides controls that allow the worker's mobile device to invoke 615 a third party device 135, in this case a GPS device, to obtain the geographical coordinates 605 for the new meter. The worker's mobile device then retrieves the coordinates from the GPS device 135. The worker reviews the geographical coordinates 605 on the custom screen interface 600 and then either chooses to accept 610 the data, or refresh the data 620, or skip the operation 625.

Custom screen interface 600 temporarily overrides the screen definitions that are configured by GUI Configuration tool 400 and disables the “Next” option 630 in the tool bar. The “Next” option 630 is used to leave the current screen, execute the workflow logic of the current screen and progress to the next appropriate screen within workflow 500. The “Next” option is re-enabled after the worker accepts the GPS coordinates or chooses to skip the operation. The worker then selects the “Next” option 630 in the tool bar to leave the custom screen interface 600 and progresses to the following screen within workflow 500. The interface releases the custom screen overrides and the next appropriate workflow screen is presented on the mobile device according to the workflow logic 500.

The workflow logic 500 then presents a “Comments” screen 520 where the worker may enter any applicable comments. After entering any applicable comments, the worker progresses to the “Complete” screen 525 and exits workflow 500.

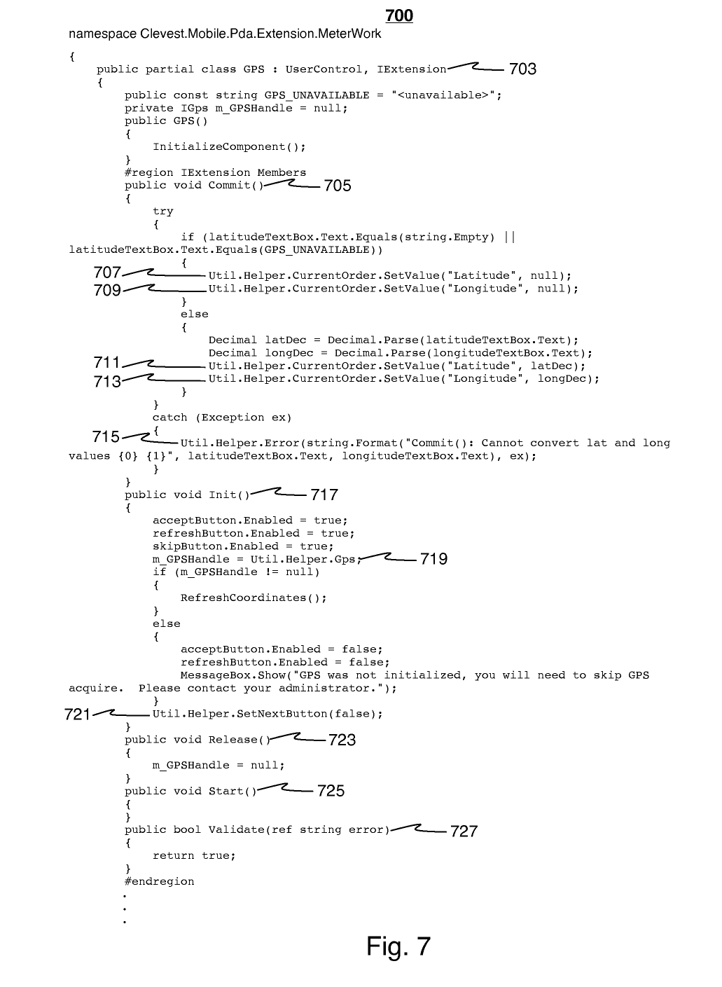

The example of the custom GPS screen 600 illustrates the extensibility of the system with third party hardware 135. FIG. 7 shows an example of extensible code 700 used for custom GPS screen 600 as illustrated in FIG. 6. In this document the term “extensible code” refers to programming code used to implement third party hardware functionality with the system.

Custom screen interfaces are created according to a published interface and may be stored as a Dynamic Link Library (DLL) in a specified directory prior to execution. The DLL is retrieved for execution when a workflow screen calls for a custom definition.

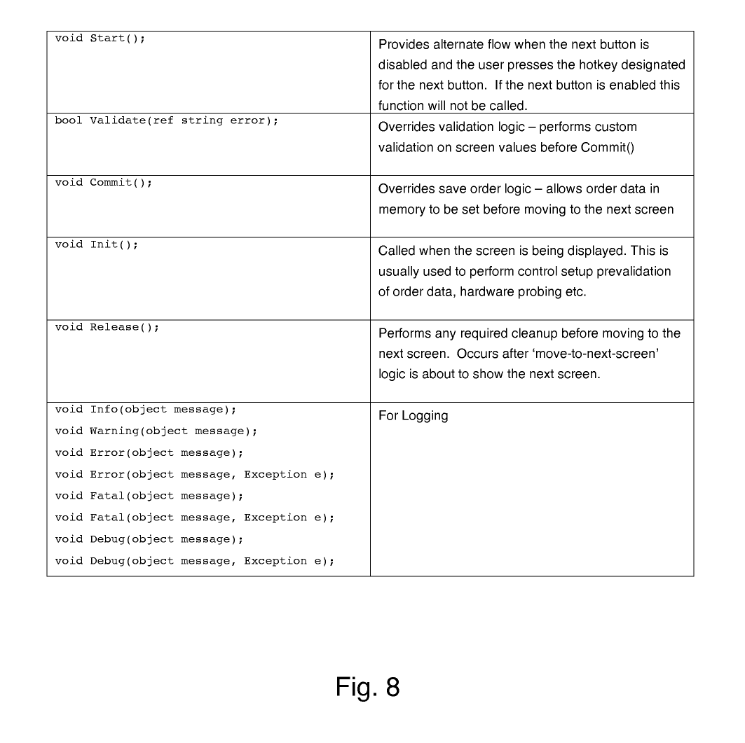

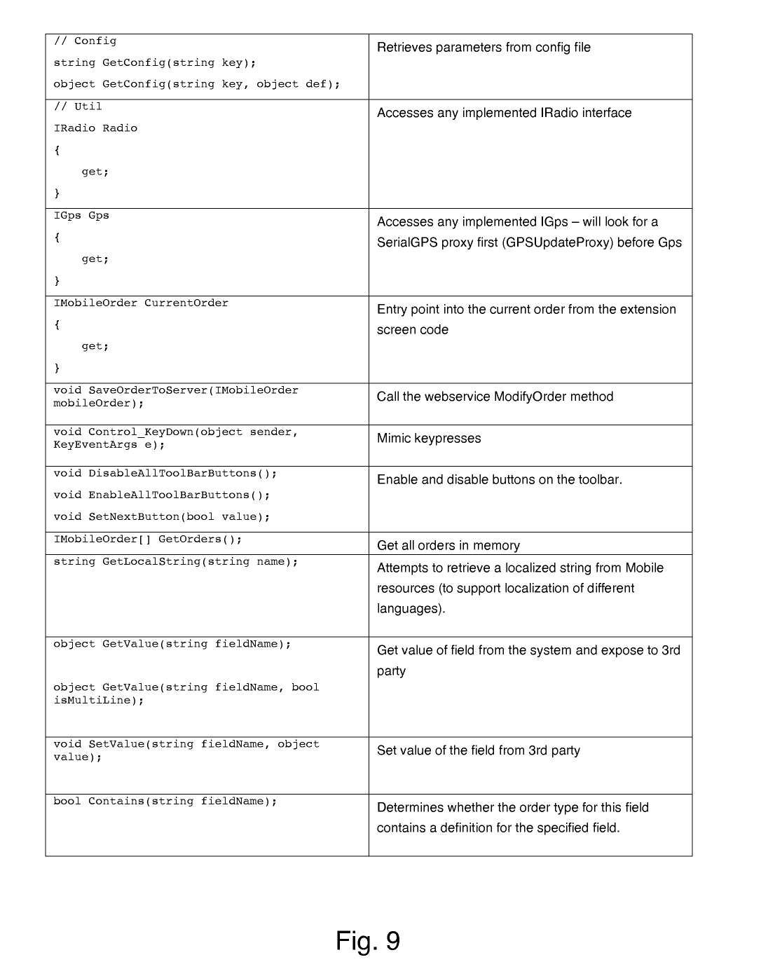

FIG. 8 and FIG. 9 show examples and definitions of published interfaces that may be used by the system. The system's use of published interfaces to integrate custom screen interfaces allows developers to create and implement custom functions and features that are not regularly configurable through the GUI configuration tool 400 and without the need to rewrite an application.

Another example of third party hardware 135 that may be integrated with the system includes specialized radios that are used for programming and testing Smart Meters that have a proprietary radio. When proprietary radios are used, the workers' mobile devices may integrate a specialized radio frequency (RF) device to invoke and/or control the Smart Meter. The workflow management system integrates the RF devices into a workflow by the same principle used to integrate GPS devices as described above. A custom screen interface may be used to allow a worker's mobile device to employ a RF device that is used to invoke, interrogate, and/or control a Smart Meter.

The system's capability to integrate third party hardware 135 is not limited to the above mentioned examples. Through the use of custom screens the system is capable of integrating any third party hardware device that can communicate through hardware interfaces such as Serial Port, Universal Serial Bus (USB), Bluetooth, and Infra Red.

The extensible workflow management system presented herein is also capable of integrating customer specific functions in the form of extensible code.

Businesses may require specific functions to be executed at particular processing points of work orders. A “processing point” is a particular event or state of processing within a work order, including, but not limited to the assignment, scheduling, completion, cancellation, status change, or uploading of a work order. Custom functions that are designed to be executed at particular processing points of a work order are referred to as “Order Event Logic”.

Order Event Logic is integrated into the system as extensible code. Order Event Logic is designed to meet the specific requirements of a particular business and may be created by in-house developers or third party programmers. The system provides an interface referred to as an OrderTypeHelper to allow the code to be integrated with the system by exposing specific classes and methods.

A an example of a scenario requiring custom Order Event Logic is illustrated by a particular business entity's need to review all completed work orders that are performed by specific employees that have been placed on probation. Custom Order Event Logic may be created to automatically determine if newly completed work orders were performed by the specified probationary employees. When any completed work orders have been identified as having been performed by the specified probationary employees, the work orders are flagged for review and the dispatcher is notified of the occurrence.

The following is an example of an interface that allows the integration of Order Event Logic on the system server:

```
namespace Clevest.Business.OrderEventLogic
{
  public class OrderTypeHelper : BaseOrderTypeHelper,
  IOrderTypeHelper
  {
    public OrderTypeHelper( );
    public virtual ActionResult OnAssign(IOrder order, IUser user);
    public virtual ActionResult OnSchedule(IOrder order, IUser user);
    public virtual ActionResult OnComplete(IOrder order, IUser user);
    public virtual ActionResult OnCancel(IOrder order, IUser user);
    public virtual ActionResult OnStatusChange(IOrder order,
    IUser user);
    public virtual ActionResult OnUpload(IOrder order, IUser user);
  }
}
```

The above interface allows the execution of custom functions at particular processing points of a work order that may be executed on a server.

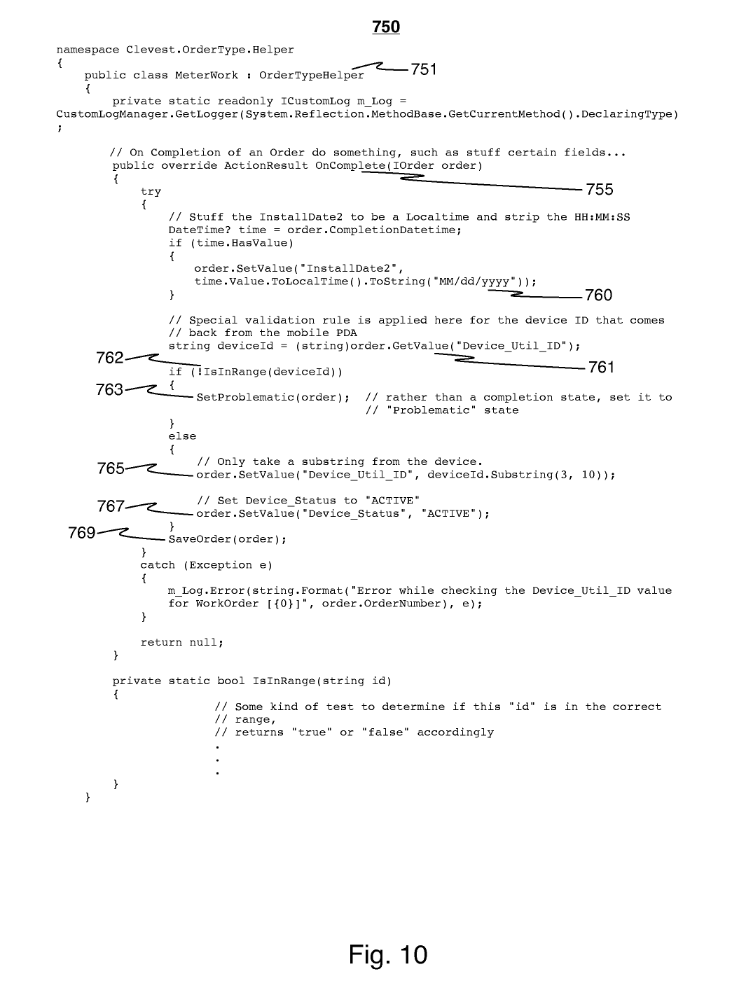

FIG. 10 shows an example of customer specific extensible code used for Order Event Logic 750 that is executed when the server receives work orders from mobile devices that are processed as a “Completion” state (shown in section 755). The “MeterWork” class extends “OrderTypeHelper” (shown in section 751) and inherits the necessary helper methods provided by the application. The custom Order Event Logic then sets a completion time with a local time in the specified format “MM/dd/yyyy” (shown in section 760) for the work order. A validation rule is used to determine if the mobile device's utility ID (shown in section 761) is within a specified range. If the device ID is not within a specified range (shown in section 762) the work order's processing state will be changed from a “Completion” state to a “Problematic” state (shown in section 763); else the system will retrieve a substring of the device ID (shown in section 765) and put the substring into a field called “Device_Utlity_ID” (also shown in section 765), and set the device status to “ACTIVE” (shown in section 767). After the validation rule has been performed the order will then be saved (shown in section 769).

The example provided in FIG. 10 illustrates the methodology that allows the system to integrate custom functions at particular processing points of a work order. In addition to validation rules, custom functions may also be complex functions that allow the system to consume Web Services, access and/or update a database, and other programmable executions.

Order Event Logic may also be implemented on mobile devices. The following is an example of the interface that allows the integration of Order Event Logic on a worker's mobile PDA:

```
namespace Clevest.Mobile.Pda.OrderEventLogic
{
  public class OrderTypeHelper : IOrderTypeHelper
  {
    public virtual IMobileOrder OnEnroute(IMobileOrder order);
    public virtual IMobileOrder OnOnsite(IMobileOrder order);
    public virtual IMobileOrder OnStartWorkflow(IMobileOrder order);
    public virtual IMobileOrder OnComplete(IMobileOrder order);
    public virtual IMobileOrder OnSkip(IMobileOrder order);
    public virtual IMobileOrder OnSuspend(IMobileOrder order);
  }
}
```

The above interface allows the use of custom functions at particular processing points during the mobile worker's processing of a work order.

Customer specific extensible code may be also be integrated to perform particular system tasks and/or system alerts.

System tasks are automated tasks that are performed by the system at particular time intervals. System tasks are created as custom code to satisfy customer specific requirements.

An exemplary system task used within a workflow management system is the automated assignment of newly received work orders to available workers, which may be executed once every hour. Automated system tasks help to remove or reduce the amount of repetitive tasks that are normally performed by a system's administrator or dispatcher.

System alerts are custom functions that are created to notify the administrator or dispatcher of particular situations and conditions that arise within the workflow management system. System alerts are created as custom code to satisfy the unique needs of different businesses.

An exemplary system alert used in a workflow management system is an alert that is created to notify a dispatcher of all unassigned work orders that are due to be performed within sixty minutes. After being notified of the unassigned work orders, the dispatcher may choose to assign the work orders to particular employees, or cancel the work orders, or dismiss the notification.

Customer specific system tasks and system alerts are integrated with workflow management application as extensible code. The workflow management application provides a published interface to integrate the extensible code. In-house programmers and third party developers may create custom code for system tasks and system alerts in accordance to the published interface.

The following is an example of the published interface that allows the integration of system tasks:

```
namespace Clevest.Business.Task.[SystemTaskName]
{
  public class [SystemTaskName] : ScheduleTask
  {
    //constructor
    public override void ExecuteTask( );
    {
    }
  }
}
```

Extensible code may be created and stored as a DLL within a specified folder in the server 101. Extensible codes are created and stored independently of the main codestream.

Providing the use of sustained published interfaces allows both the extensible code and the main codestream to be independently upgraded or modified and to remain mutually compatible. Therefore, customer specific functions and features that are created as custom code do not need to be rewritten when upgrades or modifications are made to the system's software.

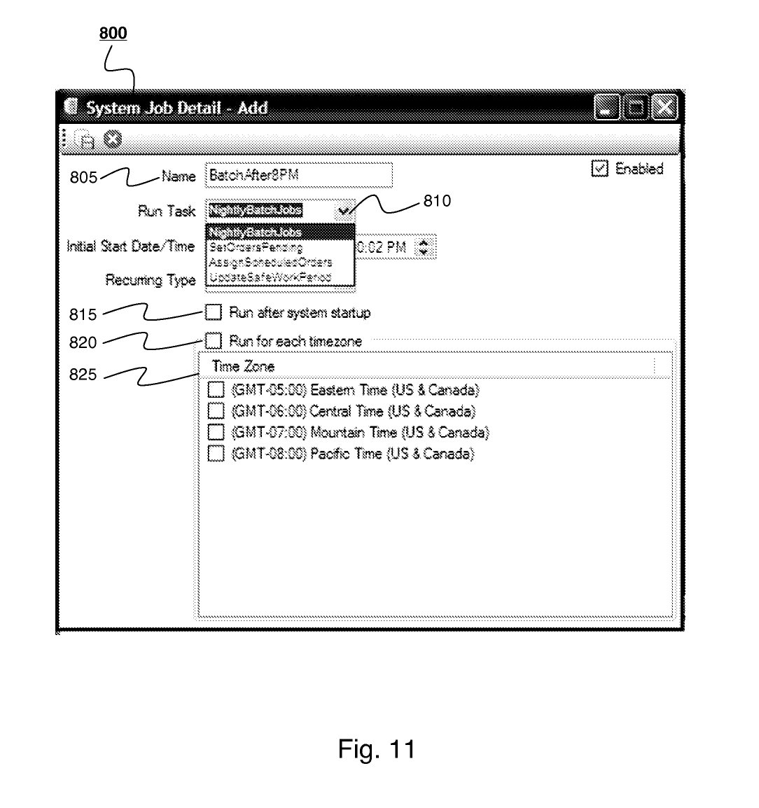

The system implements the system tasks and system alerts according to a schedule that is configurable by an administrator or dispatcher. In an example embodiment the system provides a System Job configuration tool 800, as illustrated by FIG. 11, to allow an administrator to schedule the implementation of the individual system tasks 810.

Each system task may be independently scheduled to run at system start up 815, or to recur at various time intervals. System tasks may also be scheduled according to different time zones 820 that are listed for selection in a sub screen 825.

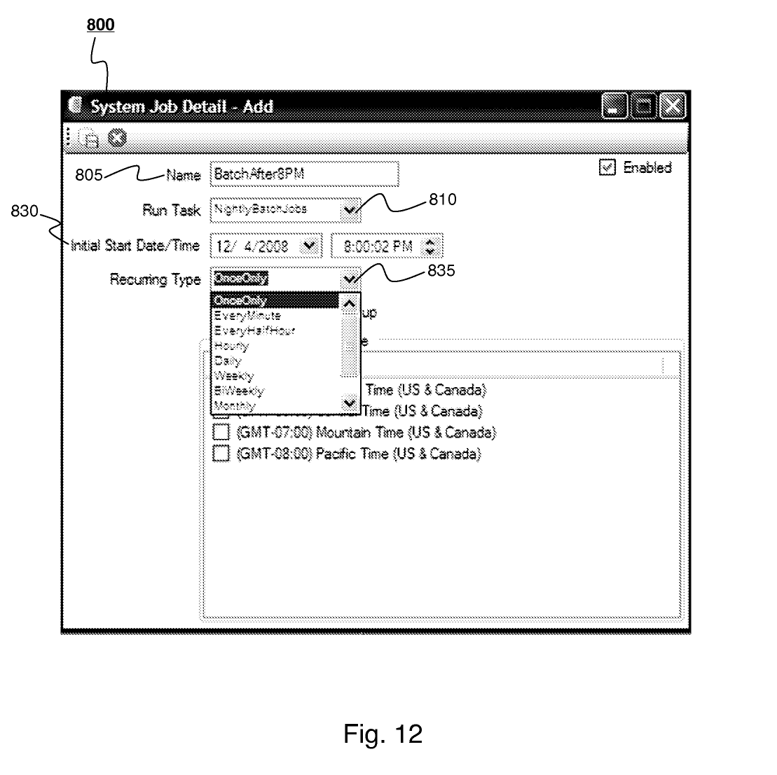

The administrator may configure system tasks to recur by using a drop down menu 835 as shown in FIG. 12. The drop down menu 835 provides a list of intervals that include every minute, every half hour, hourly, daily, monthly, or annually. The administrator may also configure the initial start date and time 830 at which the intervals are to begin. Each system task schedule may be named 805 and saved to database 105.

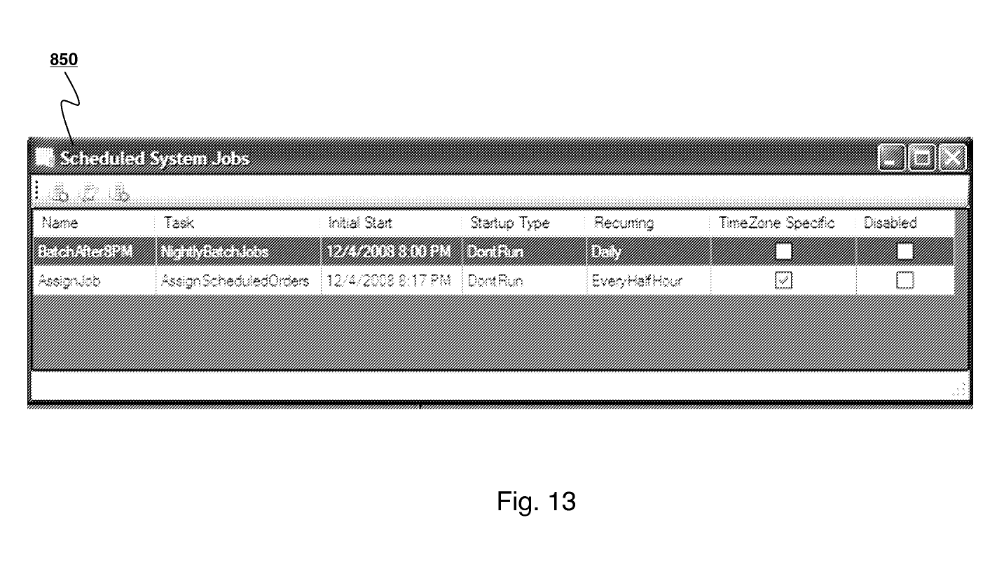

In an example embodiment the administrator may review a list of scheduled system tasks on a Scheduled System Jobs GUI screen 850 as illustrated in FIG. 13.

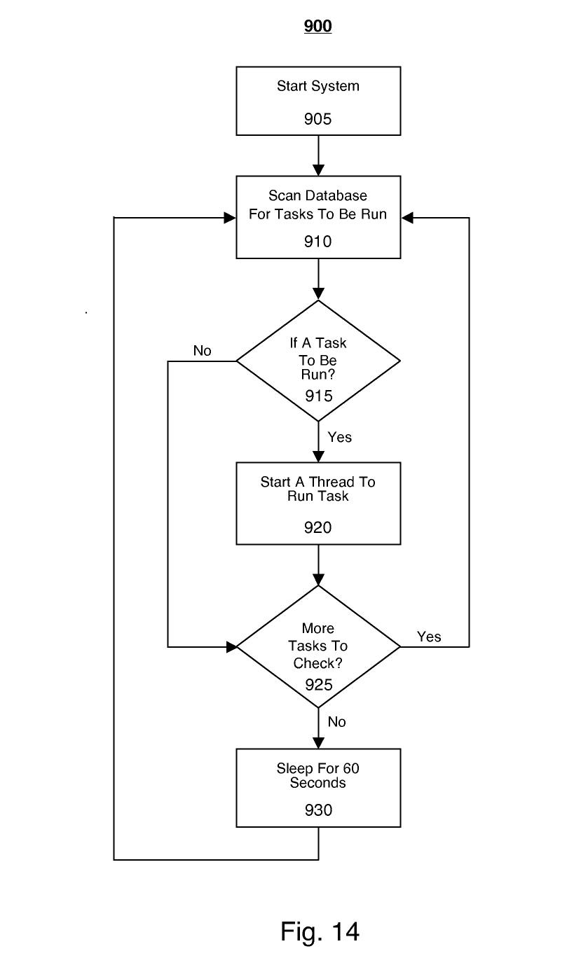

FIG. 14 illustrates an exemplary system process 900 for implementing extensible code for system tasks within a workflow management system. After system start up (step 905), the application scans the database for scheduled system tasks (step 910). The system reviews each scheduled task to determine if it is due to be run (step 915). If a particular task is due to be run, the system starts a thread to execute the system task (step 920). The system then checks if there are more tasks that need to be reviewed (step 925).

If the system reviews a particular task and determines that it is not due to be run, the system then checks if there are more tasks that need to be reviewed (step 925).

If there are additional tasks that need to be reviewed, the system reviews each additional task to determine if it is due to be run (step 915). If there are no additional tasks to be reviewed, the system sleeps for sixty seconds (step 930), after which the system again scans the database for scheduled system tasks (step 910).

A System Alert configuration tool may also be provided to allow an administrator to configure individual system alerts. The System Alert configuration tool functions under the same principle as the System Job configuration tool 800. System alerts may be individually selected and configured with a set of definable attributes including, a Reference Name that links to the specific alert DLL, Enable/Disable, Recur/Non-Recur, Recurrence Interval, Alert Message Format, and Severity Level.

Examples of system alerts include, Appointment Missed, Appointment At Risk, Emergency Order Pending, and Vehicle Exceeded Max Speed.

Although the particular preferred embodiments of the invention have been disclosed in detail for illustrative purposes, it will be recognized that variations or modifications of the disclosed apparatus lie within the scope of the present invention.

What is claimed is:

1. A system for dynamically integrating an application screen, a workflow logic for a business workflow and an extensible code, the system comprising:
an application program for executing the application screens, the workflow logic and the extensible code;
a database containing a plurality of fields and repeatables, each of said fields and repeatables corresponding to a business workflow; and the database containing an extensible code;
a graphical user interface tool producing application screens presenting the fields in conjunction with the workflow logic of the business workflow;
wherein the workflow logic for the business workflow is creatable using defined functions, logic operators, key-words, and the fields.

2. The system of claim 1 wherein a new or modified definition of:
a screen representing the business workflow, a dispatcher, or a mobile device;
or of one of the fields or repeatables,
or of the workflow logic or the extensible code,
are made available as they are added to the database.

3. A method of executing a business plan, comprising the steps of:
providing a graphic user interface, said graphic user interface providing a plurality of editable screens for implementing steps within a workflow associated with the business process;
wherein at least one of said screens is associated with extensible code, the extensible code related to input from a third party device.

4. The method of claim 3 wherein each of the plurality of screens is associated with separate workflow logic.

5. The method of claim 3 wherein the workflow includes definitions of workflow screens, dispatcher screens, mobile device screens, data fields, and the workflow logic, and wherein each of the definitions is stored as a data object in a database and made available to an application software as an executable construct.

6. The method of claim 3 wherein the graphic user interface integrates a custom screen interface into a workflow, to allow the use of an associated custom screen definition, custom control, and proprietary application program interface, and enable the integration of a third party device and associated software.

7. The method of claim 3 wherein the extensible code is integrated with the interface to allow functions to be executed at one or more processing points of a work.

8. The method of claim 3 wherein the extensible code is integrated with the interface to allow the use of customer specific system tasks.

9. The method of claim 3 wherein the interface schedules and configures an implementation of the extensible code to perform specific system tasks.

10. The method of claim 3 wherein the extensible code is integrated with the interface to allow the use of system alerts.

11. The method of claim 3 wherein the interface implements extensible code that performs system alerts.
